(19) United States
(12) Patent Application Publication
(10) Pub. No.: US 2012/0013805 A1
(43) Pub. Date: Jan. 19, 2012

(54) APPARATUS AND METHOD FOR DISPLAYING CONTENT

(76) Inventors: Isao Mihara, Tokyo (JP); Yasunobu Yamauchi, Kanagawa-ken (JP); Masahiro Sekine, Tokyo (JP); Yasukazu Higuchi, Kanagawa-Ken (JP); Junya Takakura, Tokyo (JP)

(21) Appl. No.: 13/025,766

(22) Filed: Feb. 11, 2011

(30) Foreign Application Priority Data
Jul. 16, 2010 (JP) P2010-162200

(51) Int. Cl. H04N 5/50

(52) U.S. Cl. 348/569; 348/E05.097

(57) ABSTRACT

According to one embodiment, a content database stores one or a plurality of contents and meta data thereof. An input unit inputs at least one keyword. A generation unit generates virtual meta data of a virtual content. A virtual meta data includes one or a plurality of items. An extraction unit calculates a relevance ratio between the virtual meta data and the meta data of each content, and extracts at least one relevant content from the content database, of which meta data is relevant to the virtual meta data based on the relevance ratio. A decision unit decides a location to display the relevant content based on the relevance ratio. A display unit displays the relevant content at the location. The generation unit generates the virtual meta data by writing the keyword into at least one item of the virtual meta data.

### CROSS-REFERENCE TO RELATED APPLICATION

This application is based upon and claims the benefit of priority from Japanese Patent Application No. 2010-162200, filed on Jul. 16, 2010; the entire contents of which are incorporated herein by reference.

### FIELD

Embodiments described herein relate generally to an apparatus and a method for displaying content.

### BACKGROUND

In order to select a content such as a television program, by locating a plurality of contents on a screen based on a relevance ratio thereof, a display apparatus for presenting the plurality of contents to a user is widely used.

In this display apparatus, when the user selects one content, a plurality of relevant contents having a high relevance ratio with the one content is extracted. Based on a relevance ratio between the one content and each of the relevant contents, the relevant contents are located in order on the screen.

However, in comparison with this display apparatus, a display apparatus having higher utility is desired for the user.

### BRIEF DESCRIPTION OF THE DRAWINGS

FIG. 1 is a block diagram of a display apparatus 1 according to a first embodiment.

FIG. 2 is a flow chart of processing of the display apparatus 1.

FIG. 3 is a schematic diagram of one example showing program data.

FIG. 4 is a schematic diagram of one example showing content of a genre dictionary.

FIG. 5 is a flow chart of processing of a second generation unit 122 in FIG. 1.

FIG. 6 is a schematic diagram of one example showing a display content of the display apparatus 1.

FIG. 7 is a block diagram of a display apparatus 10 according to a modification of the first embodiment.

FIG. 8 is a block diagram of a display apparatus 2 according to a second embodiment.

### DETAILED DESCRIPTION

According to one embodiment, a display apparatus includes a content database, an input unit, a generation unit, an extraction unit, a decision unit, and a display unit. The content database is configured to store one or a plurality of contents, and meta data of each content. The input unit is configured to input at least one keyword. The generation unit is configured to generate virtual meta data of a virtual content. The virtual meta data includes one or a plurality of items. The extraction unit is configured to calculate a relevance ratio between the virtual meta data and the meta data of each content, and to extract at least one relevant content from the content database, of which meta data is relevant to the virtual meta data based on the relevance ratio. The decision unit is configured to decide a location to display the relevant content based on the relevance ratio. The display unit is configured to display the relevant content at the location on the display unit. The generation unit generates the virtual meta data by writing the keyword into at least one item of the virtual meta data.

Various embodiments will be described hereinafter with reference to the accompanying drawings.

### The First Embodiment

As to a display apparatus 1 of the first embodiment, for example, it is used for a television (TV) or a recorder for a user to select programs by using an Electronic Program Guide (EPG) received from a broadcasting electronic wave. Briefly, in the first embodiment, the content is a television program.

As to television programs broadcasted on Digital Terrestrial Broadcasting or BS/CS broadcasting, program information representing detail information of the program is added as meta data (it is called “program data”). In case of Digital Terrestrial Broadcasting and BS/CS broadcasting, program data of programs is distributed by overlaying with the broadcast wave. These programs are to be broadcasted on a part of or all channels from this broadcast timing to approximately one week later.

For example, the program data includes items such as “title”, “content”, “broadcasting station”, “air time”, and “genre”.

By using keywords inputted from a user, the display apparatus 1 generates a virtual meta data of a virtual content, visualizes one or a plurality of program data (relevant program data) having high relevance ratio with the virtual meta data, and displays them. By this processing, a user can understand programs related to the keywords inputted by the user. Hereinafter, the virtual meta data is called virtual program data.

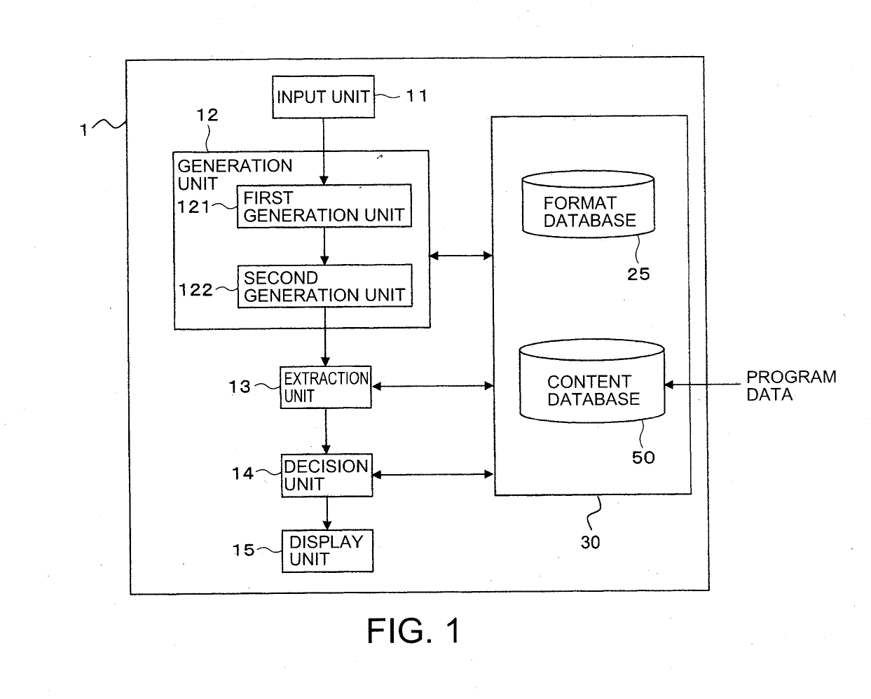

As shown in FIG. 1, the display apparatus 1 includes an input unit 11, a generation unit 12, an extraction unit 13, a decision unit 14, a display unit 15, and a storage unit 30. The storage unit 30 includes a format database 25 and a content database 50. The generation unit 12 includes a first generation unit 121 and a second generation unit 122.

The input unit 11, the generation unit 12, the extraction unit 13 and the decision unit 14, may be realized as a Central Processing Unit (CPU). The storage unit 30 may be realized as a memory used by the CPU. Moreover the format database 25 and the content database 50 may not be included in the storage unit 30, and may be stored in an auxiliary storage used by the display apparatus 1.

The content database 50 stores one or a plurality of program data received from a broadcast wave. The content database 50 may update the program data by storing program data included in a broadcast wave periodically received by a receiver (not shown in FIG. 1) which is used by the display apparatus 1.

The format database 25 stores a format of virtual program data. The virtual program data includes items such as “title”, “content”, “broadcasting station”, “air time” and “genre”. The virtual program data had better include same items as the program data.

The input unit 11 inputs one or a plurality of keywords. The generation unit 12 acquires a format of the virtual program data from the format database 25. Based on the format of the virtual program data, by writing each keyword or a keyword estimated from each keyword into at least one item, the generation unit 12 generates virtual program data. The storage unit 30 stores the virtual program data.

The first generation unit 121 writes each keyword into items except for “genre”. The second generation unit 122 estimates a genre name to be written into an item “genre” from keywords written into other items. The second generation unit 122 writes the genre name (estimated) into the item “genre”. By this processing, the virtual program data is completed.

Moreover, the second generation unit 122 may write not the genre name but a genre code (an identifier to represent a specific genre, determined by the standard) corresponding to the genre name into the item “genre”.

The extraction unit 14 calculates a relevance ratio between the virtual program data and each program data, and extracts one or a plurality of relevant program data from the content database 50, based on the relevance ratio.

The decision unit 14 decides a location of each relevant program data on the display unit 125, based on the relevance ratio. The display unit 15 visualizes and displays the relevant program data at the location decided.

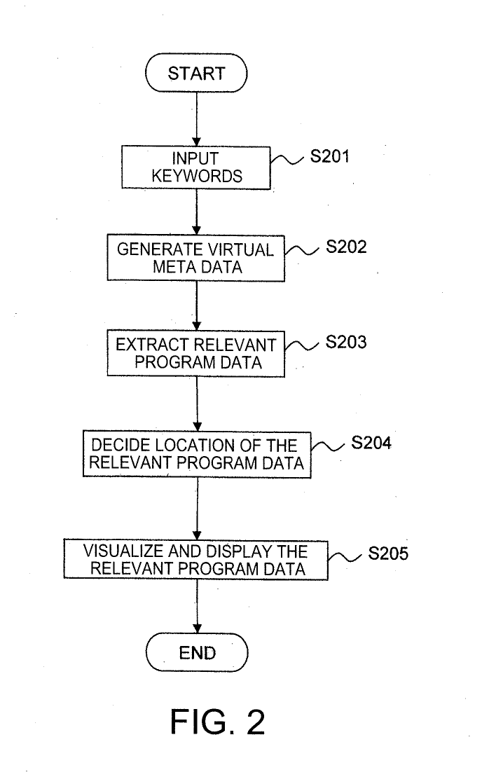

In a flow chart of FIG. 2, first, the input unit 11 inputs one or a plurality of keywords (S201). The generation unit 12 generates virtual program data from the keywords input (S202). Processing of the first generation unit 121 and the second generation unit 122 is explained afterwards.

The extraction unit 13 calculates a relevance ratio between the virtual program data and each program data, and extracts relevant program data from the content database 50 based on the relevance ratio (S203). The decision unit 14 decides a location of each relevant program data to be output on the display unit 15 based on the relevance ratio (S204).

The display unit 15 displays the relevant program data on the location decided. In this case, the display unit 15 visualizes the relevant program data as a status to be presented to a user. As mentioned-above, processing of the display apparatus 1 was explained by referring to the flow chart.

Next, detail processing of each unit is explained. First, the content database 50 is explained. The content database 50 stores one or a plurality of program data. The content database 50 stores program data of each program.

The program data is a data set representing the program, and information to explain a synopsis. Briefly, the program data is one unit of additional information for a program, and content thereof is sorted by a specific rule.

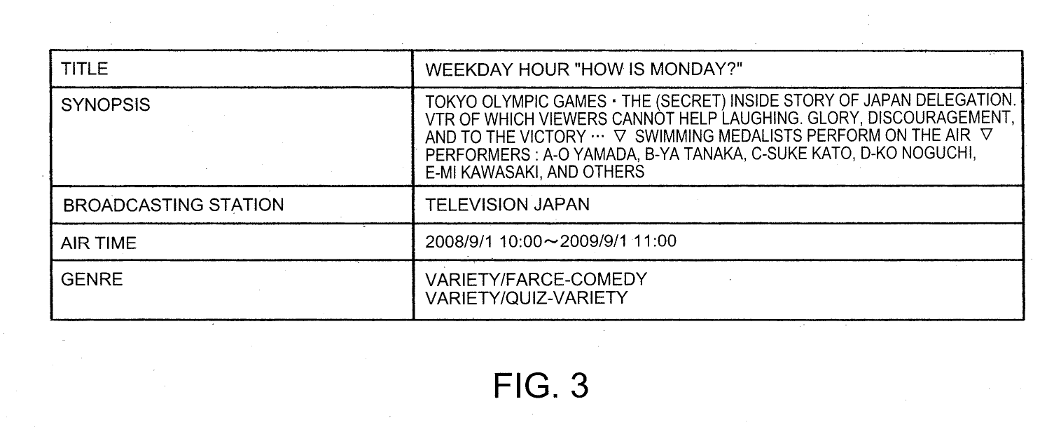

FIG. 3 is one example representing program data. For example, the program data includes “title”, “synopsis”, “broadcasting station”, “air time” and “genre”.

In this case, “title” includes a program name, “synopsis” includes an outline of the program and names of performers, “broadcasting station” includes a name of the broadcasting station, “air time” includes a start time, an end time and a duration of the broadcasting, and “genre” includes a genre name (or a genre code corresponding to the genre name) of the program.

The content database 50 may store “title” and “synopsis” as a text sentence. Furthermore, “genre” may be standardized one by Digital Terrestrial Broadcasting or BS/CS broadcasting. Each item may include a plurality of keywords.

In this case, the program represents all of a TV program to be broadcasted, a TV program being broadcasted at the present, TV programs broadcasted in the past and recorded (by a video recorder, a HDD recorder, a DVD recorder, a TV/PC having recording function).

Furthermore, as to the TV program, any broadcasting network can be used. For example, the TV program may be broadcasted by any of Digital Terrestrial Broadcasting and BS/CS broadcasting. The broadcasting network is not limited to broadcasting with a broadcast wave. The TV program may be distributed or sold by IPTV service or VOD (Video on Demand) service, or distributed on Web.

For example, if the program is a TV broadcast program, the program data is a data set such as a title and a subtitle of the TV broadcast program, a name of broadcasting station, information of broadcast type, a start time (date), an end time (date) and a duration of the broadcast, a synopsis, names of performers, a genre, a name of producer, and a caption.

In case of a TV broadcast program of the Digital Terrestrial Broadcasting, ARIB (Association of Radio Industries and Businesses) prescribes a standard format of program data. As to the Digital Terrestrial TV Broadcasting, program data having the standardized format is overlaid on the broadcast wave and distributed.

Furthermore, program data is not limited to the distribution on condition that a distributor previously assigns the program data to the broadcast wave. The program data may be added by a user afterwards. For example, as to a video recorder (including a HDD recorder) recently used, by automatically detecting a scene change or CM part from a TV broadcast program recorded, chapter information (scene change or CM part) is automatically added to the TV broadcast program. As to this equipment, a function to detect the scene change is previously installed into the equipment. This equipment generates chapter information using this function, and adds it to the program data.

Furthermore, as to some PC/TV, by recognizing faces of performers appearing in the program, a list of the faces is presented. In this case, a function to detect/recognize face is installed into such equipment. This equipment adds a name of performer to the program data using this function.

The input unit 11 inputs one or a plurality of keywords. By using an input device (not shown in Fig.) such as a keyboard, a mouse or a remote controller (equipped with the display apparatus 1), a user may one or the plurality of keywords. For example, by presenting a dialogue box to input keywords on the display unit 15, the keyword inputted by the user may be displayed.

The generation unit 12 acquires a format of virtual program data from the format database 25. By writing each keyword or a keyword (estimated from each keyword) into at least one item based on the format, the generation unit 12 generates the virtual program data. The storage unit 30 stores the virtual program data.

The generation unit 12 includes the first generation unit 121 and the second generation unit 122. For example, the first generation unit 121 may estimate a meaning of each keyword by analyzing each keyword with words semantic analysis, and decide an item (of the virtual program data) to write each keyword based on the meaning.

In this case, the words semantic analysis is technique to extract a keyword (including the name of a person) with a semantic category thereof. By using this technique, from many semantic categories such as a well-known person's name, a politician's name, a historical person's name, a character name, a place name, an organization name, a sports term and health/medical term, at least one semantic category suitable for the keyword can be estimated. For example, this processing method is disclosed in following two references.
“A Study of the Relations among Question Answering, Japanese Named Entity Extraction, and Named Entity Taxonpmy”, Y. Ichimura et al., NL-161-3, pp. 17-24, 2004
“Implementation of TV-program Navigation System Using a Topic Extraction Agent”, T. Yamasaki et al., Computer Software 25(4), pp. 41-51, 2008

Furthermore, the first generation unit 121 may connect all input keywords as one sentence by a specific delimiter (For example, “,” (comma)). The first generation unit 121 may write this one sentence into an item “title” or “synopsis” of virtual program data. For example, if input keywords are “◯◯◯”, “XXX” and “ΔΔΔ”, the first generation unit 121 generates one sentence “◯◯◯, XXX, ΔΔΔ”. The first generation unit 121 may write this one sentence into items “title” and “synopsis” of the virtual program data.

Furthermore, the first generation unit 121 may determine a priority of each keyword, and write a keyword having high priority into an item “title” of the virtual program data. The first generation unit 121 writes other keywords into an item “synopsis” of the virtual program data.

In this case, by using a meaning of the keyword analyzed with above-mentioned words semantic analysis, the priority may be determined. For example, if the meaning of the keyword is “well-known person”, this keyword may be written into “title”. If the keyword has another meaning, this keyword may be written into an item “synopsis”. Furthermore, if the meaning of the keyword is a concrete “commodity name”, this keyword may be written into an item “title”. If the meaning of the keyword is a general term, this keyword may be written into an item “synopsis”.

For example, the first generation unit 121 may determine a priority of each keyword by an input order. Briefly, as to keywords from the first inputted one to the N-th (N: natural number) inputted one, these keywords may be written into an item “title” of the virtual program data. Other keywords may be written into an item “synopsis” of the virtual program data. Furthermore, the priority of each keyword may be indicated by the user. In this case, the input unit 11 accepts the priority of each keyword from the user.

If one or a plurality of keywords includes a name of a specific broadcasting station (or its abbreviation), the first generation unit 121 writes the name into an item “broadcasting station” of the virtual program data. For example, by using a dictionary of broadcasting stations (not shown in Fig.) representing names of broadcasting stations (or their abbreviations), if a keyword matches the name of broadcasting station or its abbreviation, the first generation unit 121 may acquire the name of broadcasting station from the dictionary, and write the name into an item “broadcasting station” of the virtual program data. The dictionary of broadcasting stations may be stored into the storage unit 30.

The second generation unit 122 estimates a genre of the virtual program data from keywords written into items except for “genre”. The second generation unit 122 has a genre dictionary (not shown in Fig.) representing a genre corresponding to each keyword. By deciding whether a keyword is included in the genre dictionary, the second generation unit 122 may estimate a genre of the keyword. The genre dictionary may be stored into the storage unit 30.

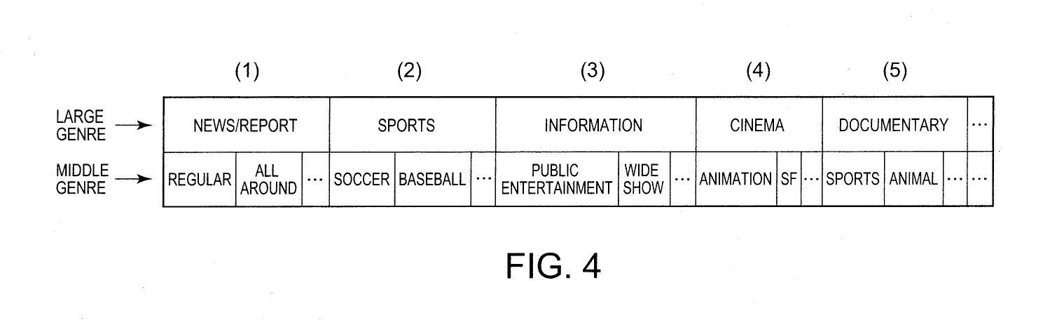

FIG. 4 is one example of content of the genre dictionary. As to the genre dictionary, a large genre class as the highest hierarchical level and a middle genre class as more detailed class of the large genre class are included. In case of (2) of FIG. 4, “sports” is the large genre class, and “soccer” is the middle genre class. Moreover, each genre included in the genre dictionary may be standardized one by ARIB (Association of Radio Industries and Businesses).

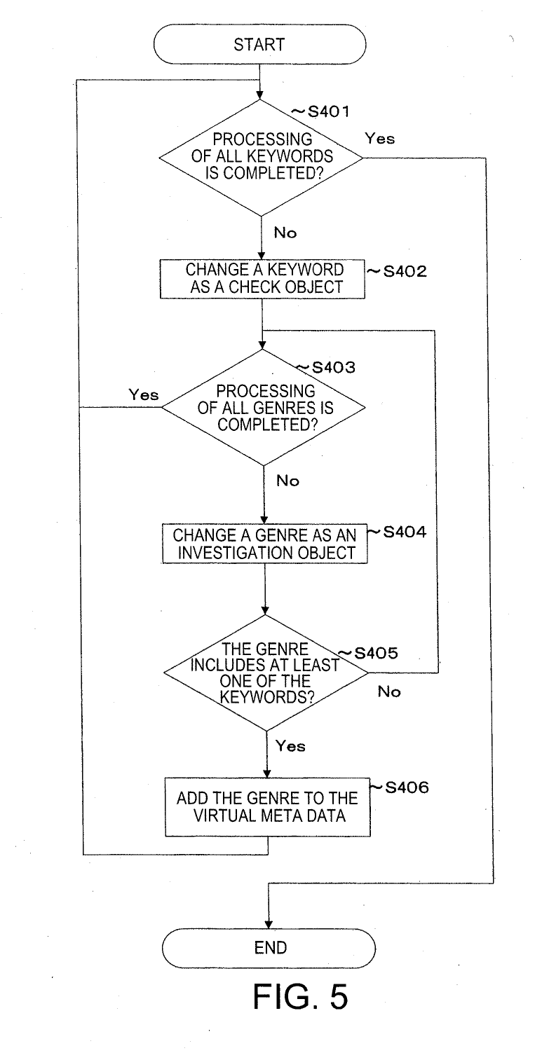

FIG. 5 is a flow chart of processing of the second generation unit 122. The second generation unit 122 decides whether processing of all keyword is completed (S401). If this decision is YES, processing is completed.

If this decision is NO, a check object is changed from the present keyword to a next keyword (S402). If any keyword is not set as the check object yet, among one or a plurality of keywords acquired from the input unit 11, a keyword inputted first is set as the check object.

The second generation unit 122 decides whether investigation of all genres (stored in the genre dictionary) is completed for one keyword (S403). If this decision is YES, processing is forwarded to S401. If this decision is NO, an investigation object is changed from the present genre to a next genre (S404).

The second generation unit 122 decides whether the keyword as the check object is included in a character string of a genre name of the investigation object (S405). If this decision is NO, processing is forwarded to S403. If this decision is YES, the second generation unit 122 adds a genre name (the large genre is desired) of the investigation object to an item “genre” of the virtual program data (S406), and processing is returned to S401.

For example, if a keyword of the check object is “sports”, genres of (2) and (5) in FIG. 4 include a character string “sports”. Accordingly, the second generation unit 122 adds “sports” and “documentary” to an item “genre” of the virtual program data.

When a plurality of genres is written into an item “genre”, the second generation unit 122 may assign a priority of each of the plurality of genres. In above-mentioned example, the second generation unit 122 may assign a high priority to the large genre “documentary” having the middle genre of which character string is matched with “sports”.

Moreover, above-mentioned example is simplified for explanation, and processing of the first embodiment is not limited thereto. In this example, at S405, it is decided whether a keyword of the check object is included in a character string of genre name of the investigation object. However, decision processing is not limited to this example. For example, by further using a dictionary of synonyms (not shown in Fig.), even if a synonym of the keyword of the check object is included, the second generation unit 122 may decide to be YES at S405. The dictionary of synonyms may be stored into the storage unit 30. Furthermore, without the dictionary of synonyms, the second generation unit 122 may acquire synonyms by retrieving a dictionary or Web page on Internet.

As to each program data stored in the content database 50, the extraction unit 13 calculates a relevance ratio between virtual program data and each program data. For example, the extraction unit 13 calculates the relevance ratio using a method disclosed in US-A 20090080698 (JP-A 2009-80580).

Based on the relevance ratio, the extraction unit 13 extracts one or a plurality of relevant program data with the relevance ratio. For example, the extraction unit 13 extracts program data of which relevance ratio is larger than a specific threshold, as a relevant program data.

The decision unit 14 decides each location of one or a plurality of relevant program data on the display unit 15. Briefly, based on the relevance ratio, the decision unit 14 decides a location of each relevant program data to be presented on the display unit 15. For example, the decision unit 14 may locate a relevant program data having high relevance ratio at a center part of the display unit 15.

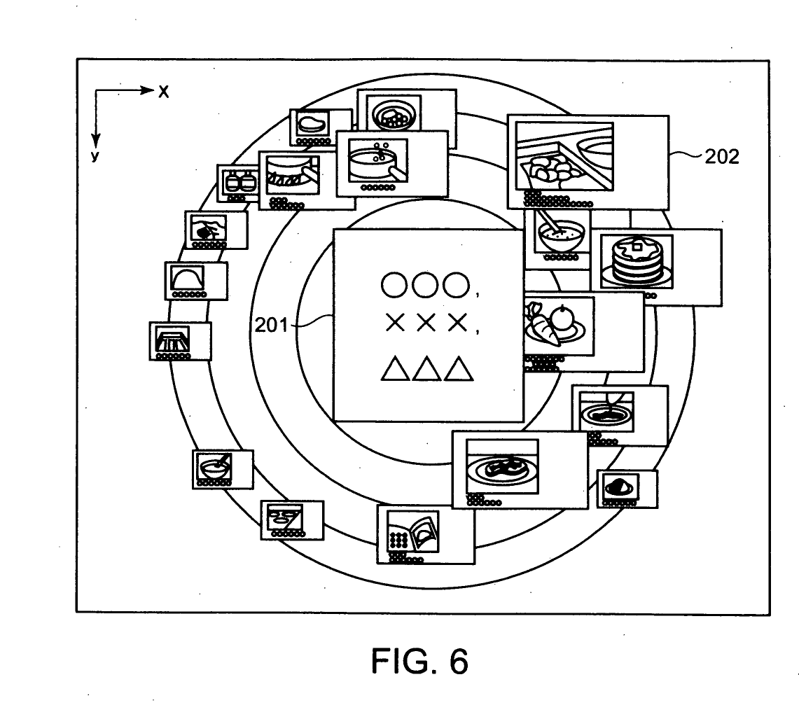

The display unit 15 visualizes/displays keywords and relevant program data at the location decided. FIG. 6 is one example showing a display content on the display unit 15. In FIG. 6, a sign 201 represents input keywords “◯◯◯, XXX, ΔΔΔ” from the input unit 11. A sign 202 represents one of relevant program data visualized.

For example, the decision unit 14 may decide to locate the input keywords “◯◯◯, XXX, ΔΔΔ” at a center position, and the display unit 15 may display the input keywords at the center position. Furthermore, the decision unit 14 may locate relevant program data at a shape of concentric circle around the keywords, based on the relevance ratio. In this case, relevant program data having high relevance ratio is located at a position nearer the keywords. The display unit 15 visualizes and displays the relevant program data at the location decided.

For example, if the program has thumb-nail such as a recorded program, the display unit 15 may display the relevant program data by visualizing this thumb-nail. Alternatively, the display unit 15 may display character strings such as a title and a synopsis of the program.

As to the first embodiment, program data (relevant program data) related to one or a plurality of input keyword by the user is displayed based on the relevance ratio thereof. Accordingly, the display apparatus and the display method having higher utility for the user can be provided.

(Modification)

As to a display apparatus 10 of a modification of the first embodiment, keywords included in relevant program data displayed on the display unit 15, and keywords included in arbitrary program data stored in the content database 50, are presented as keyword candidates to the user.

The display apparatus 10 makes the user select one or a plurality of keywords from the keyword candidates. As to one of the plurality of keywords selected by the user, the display apparatus 10 presents relevant program data to the user using above-mentioned method. By this processing, the user can know the relevant program data without inputting keywords.

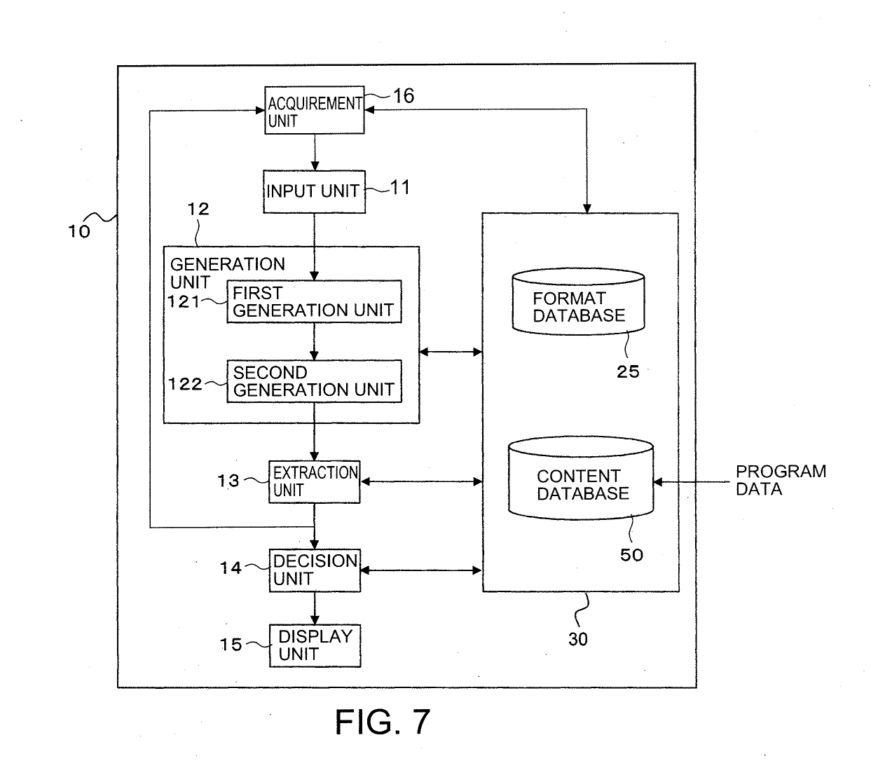

FIG. 7 is a block diagram of the display apparatus 10 according to the modification. In comparison with the display apparatus 1 of the first embodiment, the display apparatus 1 further includes an acquirement unit 16.

The acquirement unit 16 acquires one or a plurality of keywords from one or a plurality of program data stored in the content database 50 or from text sentences included in one or a plurality of relevant program data extracted by the extraction unit 13.

The acquirement unit 16 outputs one or the plurality of keywords to the input unit 11. The input unit 11 presents one or the plurality of keywords as keyword candidates to the user, and makes the user select arbitrary keywords. After the user has selected arbitrary keywords, each unit executes the same processing as the first embodiment.

### The Second Embodiment

As to the second embodiment, a display apparatus 2 is used for a digital camera to preserve a captured image (image data) with meta data related to information of capture timing thereof. Briefly, in the second embodiment, the content is the captured image.

The display apparatus 2 generates virtual meta data of a virtual captured image by using keywords inputted by the user, and displays a captured image (a relevant image) of which meta data has high relevance ratio with the virtual meta data. Hereinafter, the virtual meta data is called virtual image data.

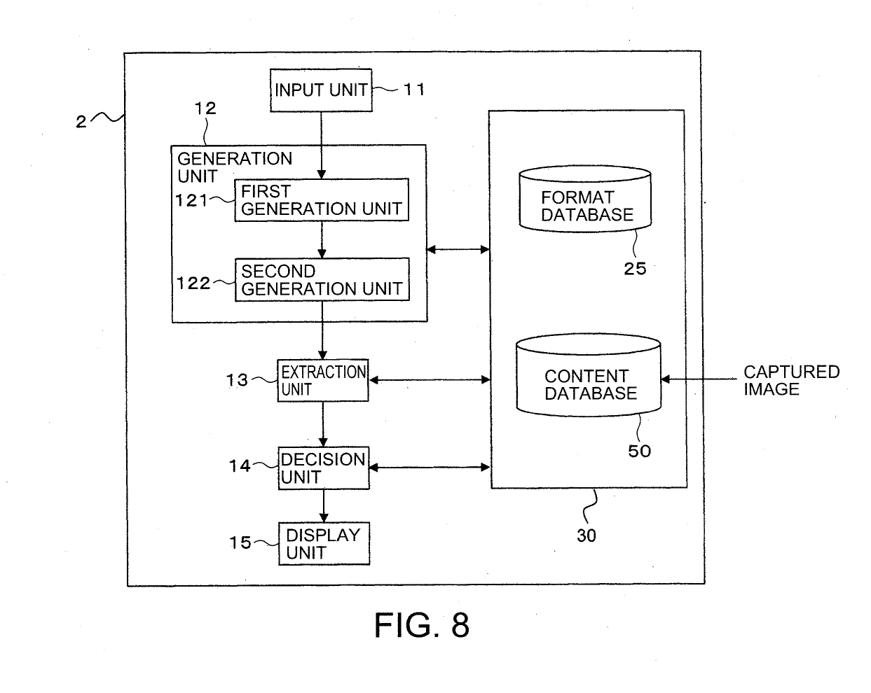

FIG. 8 is a block diagram of the display apparatus 2. In the second embodiment, data stored in the format database 25, data stored in the content database 50, and virtual data generated by the generation unit 12, are related to the captured image. This feature is different, from the first embodiment.

The content database 50 stores an image actually captured, and meta data added to the image as capture data. The meta data (capture data) includes items such as “camera parameter at capture timing”, “location (For example, GPS information) of a capture place”, “capture date and time” and “memorandum”. The format database 25 previously stores a format of virtual image data. The virtual image data includes items such as “camera parameter at capture timing”, “location (For example, GPS information) of a capture place”, “capture date and time” and “memorandum”.

The input unit 11 inputs one or a plurality of keywords. The generation unit 12 acquires a format of virtual image data from the format database 25. By writing each keyword or a keyword estimated from each keyword into at least one item of the format, the generation unit 12 generates virtual image data. The storage unit 30 stores the virtual image data.

The first generation unit 121 writes one or a plurality of input keywords into at least one item of the format of the virtual image data. The first generation unit 121 may previously have a criterion to decide an item (of the virtual image data) to write the keyword. For example, when a keyword “2010 year” is inputted, the first generation unit 121 writes the keyword into an item “capture date and time” by referring to the criterion.

As to an item (of virtual image data) unable to write keywords based on the criterion, the second generation unit 122 estimates information (supplemental information) supplemented from the keywords. The second generation unit 122 writes the supplemental information into the item of virtual image data.

For example, when GPS information (longitude, latitude) is inputted, by using a geographical dictionary (not shown in Fig.) representing correspondence between GPS information and a name of place, the second generation unit 122 acquires the name of place indicated by the GPS information. The second generation unit 122 writes the name of place into an item “memorandum” of virtual image data.

The extraction unit 13 extracts a captured image (relevant image data) related to the virtual image data from the content database 50. In this case, the extraction unit 13 calculates a relevance ratio between the virtual image data and each image data, and extracts relevant image data based on the relevance ratio.

The decision unit 14 decides a location of each relevant capture data on the display unit 15. The display unit 15 visualizes and displays the relevant capture data at the location decided. In this case, the display unit 15 may display only a captured image included in the relevant capture data.

As mentioned-above, according to the second embodiment, the display apparatus and the display method having higher utility for the user can be provided.

In above-mentioned embodiments, a TV, a recorder, and a digital camera, are explained as usage examples. However, usage examples are not limited to them. Briefly, the first and second embodiments can be applied to all devices to present content to the user. Furthermore, the content is not limited to a TV program and a captured image. For example, the content may be commodity information of communication sales or book information on Web.

In the disclosed embodiments, the processing can be performed by a computer program stored in a computer-readable medium.

In the embodiments, the computer readable medium may be, for example, a magnetic disk, a flexible disk, a hard disk, an optical disk (e.g., CD-ROM, CD-R, DVD), an optical magnetic disk (e.g., MD). However, any computer readable medium, which is configured to store a computer program for causing a computer to perform the processing described above, may be used.

Furthermore, based on an indication of the program installed from the memory device to the computer, OS (operation system) operating on the computer, or MW (middle ware software), such as database management software or network, may execute one part of each processing to realize the embodiments.

Furthermore, the memory device is not limited to a device independent from the computer. By downloading a program transmitted through a LAN or the Internet, a memory device in which the program is stored is included. Furthermore, the memory device is not limited to one. In the case that the processing of the embodiments is executed by a plurality of memory devices, a plurality of memory devices may be included in the memory device.

A computer may execute each processing stage of the embodiments according to the program stored in the memory device. The computer may be one apparatus such as a personal computer or a system in which a plurality of processing apparatuses are connected through a network. Furthermore, the computer is not limited to a personal computer. Those skilled in the art will appreciate that a computer includes a processing unit in an information processor, a microcomputer, and so on. In short, the equipment and the apparatus that can execute the functions in embodiments using the program are generally called the computer.

While certain embodiments have been described, these embodiments have been presented by way of examples only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A display apparatus comprising:
a content database configured to store one or a plurality of contents, and meta data of each content;
an input unit configured to input at least one keyword;
a generation unit configured to generate virtual meta data of a virtual content, the virtual meta data including one or a plurality of items;
an extraction unit configured to calculate a relevance ratio between the virtual meta data and the meta data of each content, and to extract at least one relevant content from the content database, of which meta data is relevant to the virtual meta data based on the relevance ratio;
a decision unit configured to decide a location to display the relevant content based on the relevance ratio; and
a display unit configured to display the relevant content at the location on the display unit;
wherein the generation unit generates the virtual meta data by writing the keyword into at least one item of the virtual meta data.

2. The apparatus according to claim 1, wherein
the extraction unit extracts the at least one content of which meta data has the relevance ratio larger than a specific threshold from the content database, as the relevant content.

3. The apparatus according to claim 2, wherein
the generation unit decides the at least one item of the virtual meta data to write the keyword, in order of input of the keyword.

4. The apparatus according to claim 2, wherein
the generation unit decides the at least one item of the virtual meta data to write the keyword, by semantically analyzing the keyword.

5. The apparatus according to claim 2, wherein
the generation unit estimates a new keyword to be written into another item of the virtual meta data, from the keyword written into the at least one item.

6. The apparatus according to claim 1, wherein
the content is a TV program, and
the virtual meta data includes a title and a synopsis of the TV program as each item.

7. The apparatus according to claim 6, further comprising:
an acquirement unit configured to acquire text sentences included in the meta data of each content stored in the content database, and to output the text sentences to the input unit.

8. A display method comprising:
storing in a content database, one or a plurality of contents, and meta data of each content;
inputting at least one keyword;
generating virtual meta data of a virtual content, the virtual meta data including one or a plurality of items;
calculating a relevance ratio between the virtual meta data and the meta data of each content;
extracting at least one relevant content from the content database, of which meta data is relevant to the virtual meta data based on the relevance ratio;
deciding a location to display the relevant content on a display unit, based on the relevance ratio; and
displaying the relevant content at the location on the display unit;
wherein the generating includes
writing the keyword into at least one item of the virtual meta data.
